(19) United States
(12) Patent Application Publication
(10) Pub. No.: US 2002/0070932 A1
(43) Pub. Date: Jun. 13, 2002

(54) Universal three-dimensional graphics viewer for resource constrained mobile computers

(76) Inventor: Jesse Jaejin Kim, San Jose, CA (US)

Correspondence Address: Jesse Kim, 1198 Morrill Court, San Jose, CA, 95132, US

(21) Appl. No.: 09/734,278

(22) Filed: Dec. 10, 2000

(51) Int. Cl. G09G 5/00; G06T 15/00

(52) U.S. Cl. 345/419

(57) ABSTRACT

A 3D graphics system includes a mobile device adapted to receive a 3D graphics file in one or more formats; code to converting the file into a universal format; code to decompress the file; and code to render the file into a 3D image.

### BACKGROUND OF THE INVENTION

This invention relates to a computerized three-dimensional visualization system for resource constrained mobile computers.

The advent of computer technology has made significant impact on the illustration and visualization of objects. It is often desirable to be able to present three-dimensional (3D) images on a flat display of a computer system. For example, in computer-aided design (CAD) and in computer animation, it may be desirable to have a three-dimensional representation of an object when preparing perspective views of three-dimensional scenes. In these systems, 3D objects can be displayed in an isometric or perspective view on the screen of the computer system.

Typically, three-dimensional objects are represented for computerized manipulation and use as a “wire frame,” which consists of a number of vertices (i.e., points) in three-dimensional space specified with reference to a coordinate system. The points in three-dimensional space are typically joined by lines to create sets of linked or related polygons. Each polygon usually represents a generally flat surface element depicting a portion of the object being represented.

A variety of algorithms have been developed to permit a realistic rendering of 3D images on the computer screen. Examples of such algorithms include hidden line and surface generating algorithms, and shading algorithms such as ray tracing algorithms and radiative algorithms. These algorithms can be implemented in software, hardware, or a combination of the two. The 3D rendering algorithms typically consume significant floating point operations and thus historically have required high performance computers and workstations such as computers from Silicon Graphics, Inc. or custom graphic boards such as the Oxygen series of graphics boards, available from 3DLabs, Inc.

Once created, 3D contents need to be properly formatted for viewing using a 3D viewer. For conventional computers, standard formats such as VRML have been proposed. However, due to bulky file format and large data requirement of VRML, many 3D graphics solution providers have their own file formats. This is evident when a user tries to view 3D graphic contents over the Internet. The user is often asked to download a plug-in or separate viewer software over the net so that the contents can be viewed. When the user tries to view 3D contents from different sites built with 3D graphics technologies from various vendors, he has to download a variety of plug-ins, which can consume storage space. A user may end up with several megabytes of many different viewers as plug-ins or as separate viewers on his computer.

In another trend, advances in microprocessor, memory and display technology have endowed mobile users with information on their fingertips. Users are being enticed to shift their processing from desktop based computers to portable computing appliances such as handheld computers, palm-sized computers and other wearable computers. To support mobile computing, most handheld computers have small screens and use power judiciously through aggressive power management schemes. These handheld computers deploy a variety of processors, including 16-bit CISC processors such as the 68000 and 32-bit RISC processors such as the ARM processor. Examples of these handheld computers include the Palm computer, available from Palm, Inc. and Windows CE computer, available from a plurality of sources such as Compaq Computer Corporation, Casio, and Hewlett-Packard, Inc. The handheld computers typically offer built-in applications which include, among others, an appointment book to keep track of meetings and to-do lists, a phone book to store phone numbers and other contact information, a notepad for simple word processing applications, and a world time clock which shows time around the world and city locations on a map. In addition to built-in applications, add-on applications can be downloaded to the handheld computers.

Currently, no standard exists for a 3D graphics file format for handheld computers. Additionally, there is no standard rendering system for handheld computers. For conventional personal computers provide APIs such as Direct-3D or OpenGL—usually associated with hardware graphics accelerators—to allow faster execution of graphics programs and to make it easier for software programmers to develop 3D graphics-related applications and tools. The API also reduces the overall code size. Since wireless and handheld devices do not support a 3D API, graphics software running on handheld computers provides its own software graphics renderer. This increases the code size of each 3D graphics viewer, and requires multiple viewers in such devices. This presents a problem in wireless and handheld device environments: due to limited memory capacity, a user may not be able to download a plurality of viewers on handheld computers.

### SUMMARY

In one aspect, a 3D graphics system includes a server to receive a 3D file, the 3D file conforming to one or more formats; and a handheld device adapted to communicate with the server the 3D file, the handheld device capable of visualizing the 3D file.

Implementations of the above aspect may include one or more of the following. The server performs file conversion. The server compresses the 3D file. Code can be stored on the server and downloaded to the handheld device as needed, or alternatively, code can be embedded in the handheld device. The server stores secure subscriber account information, data, and applications to facilitate 3D file conversion. The handheld device handles recording, playback, editing, storage, conversion, controlling, interacting, management and transmission of a 3D graphics file from the handheld device to the server. The server provides version control to allow a user to restore a prior file. The handheld device can be a cellular phone, personal digital assistant, or a resource-constrained mobile computer. The server can be connected to the Internet.

In another aspect, a mobile 3D visualization system includes a handheld device adapted to receive graphics files from a plurality of sources conforming to a plurality of file formats; and a server coupled to the handheld device, the server distributing the 3D graphics file to the device.

In yet another aspect, software for a 3D graphics mobile device to visualize a 3D graphics file stored in one or more 3D file formats includes: code to converting the file into a universal format; code to decompress the file; and code to render the file into a 3D image.

Implementations of the above aspect may include one or more of the following. The render code avoids the rendering of small details not observable on a mobile device screen to accelerate displaying the 3D image on the mobile device. Code can be stored on the server and downloaded to the handheld device as needed, or alternatively, code can be embedded in the handheld device. The mobile device handles recording, playback, editing, storage, conversion, management and transmission of a 3D graphics file from the handheld device to the server. The device can be a cellular phone, personal digital assistant, or a resource-constrained mobile computer.

In another aspect, software for a 3D graphics mobile device to visualize a 3D graphics file stored in one or more 3D file formats includes code to converting the file into a universal format; code to decompress the file; and code to render the file into a 3D image.

Implementations of the above aspect may include one or more of the following. The render code avoids the rendering of small details not observable on a mobile device screen to accelerate displaying the 3D image on the mobile device. The software includes code to perform resolution skipping operations on objects. The software includes code to approximating an object as a sphere for purposes of lighting transformation. The software includes code to perform anti-aliasing operations only on stationary objects. The software includes code to perform frame skipping where, for even frames, only even lines are drawn and, for odd frames, only odd lines are drawn. The software includes code to perform world transformation operation only once for non-moving objects. The software also converts each input file format into the universal file.

In another aspect, a universal graphics viewer is disclosed that supports multiple file formats. This means that a user can have only one viewer installed on his/her handheld device and view graphics files with different formats.

In one implementation, various file formats are translated to one ‘universal’ file format before a 3D object is displayed. The translation can be done either on the handheld device, or on a server or other external computers before the file is loaded on to the device.

In another implementation, the viewer understands different types of file formats and displays each file format using its unique file structure. One way is a ‘brute force’ approach where the universal viewer will have separate routines or modules for each of the file format. In this case, the viewer is basically a ‘collection’ of many different viewers, except for the fact that it shares a common graphics renderer (which is still a good code size saving). Another way is to build common modules that decode multiple formats. This method takes advantages of the fact that even though all proprietary files have different formats, they often have similar structures. For example, a typical graphics file would have any combination of the following four components: polygon structure information, texture information, lighting information, and animation instructions. For each of the components, different file formats would have different sub-structures. In a grossly simplified example, one file may have polygon structure information read 2 bytes at a time, and another would have it read 4 bytes at a time. The universal viewer's polygon structure decoding module would know how many bytes to be read for each of the file formats it supports, and would read them correctly—using one common program, with a unique ‘switch’ value that corresponds to each of the file formats.

Advantages of the invention may include one or more of the following. The viewer or reader can read a universal 3D document that, once created, can be viewed, navigated and printed in any handheld platform by using the viewer. The invention adds functionality to documents and significantly reduces the file size required to faithfully reproduce the original document regardless of the handheld platform used to read the document—for example, 3D graphic documents can be compressed from their original size. The viewer supports bookmark, thumbnail, annotate, and link, among others. Moreover, documents conforming to the 3D API of the invention can be easily communicated through a Web site due to smaller file size and the ease of preparing and uploading the document to the Web. Further, after downloading, users receive an easily manageable document that can be navigated through using thumbnail sketches, links, and bookmarks. Further, the system is fast since it skips 3D graphics operations on details that are not observable on a small screen of the handheld device.

### BRIEF DESCRIPTION OF THE DRAWINGS

FIG. 1 shows an environment for processing a 3D visualization on handheld devices.

FIG. 2 shows an exemplary handheld device.

FIG. 3 shows an exemplary architecture for software supported by the server.

FIG. 4 shows an exemplary flowchart for receiving and displaying 3D models on the handheld device.

FIG. 5 shows an exemplary 3D model data structure to be rendered on the handheld device by the process of FIG. 4.

FIGS. 6A-D show a process for visualizing 3D models of different formats on the handheld device.

FIGS. 7A-7E show various embodiments of a 3D visualization system on the handheld device.

FIG. 8 shows a flowchart of a process to accelerate rendering of 3D objects on the handheld device.

### DETAILED DESCRIPTION

FIG. 1 shows an environment for processing a 3D transaction on handheld devices such as cellular telephones, personal digital assistants (PDA), mobile and handheld computers, and other resource constrained mobile computing devices. A server 100 is connected to a network 102 such as the Internet. One or more clients 104-106 can be connected to the network 102 over landline or wireless medium. The clients 104-106 can be cellular telephones, personal digital assistants (PDA), mobile and handheld computers, and other mobile computing devices. Alternatively, the clients 104-106 can be personal computers or workstations.

An Internet community 110 with one or more 3D related companies, service providers, manufacturers, or marketers is connected to the network 102 and can communicate directly with users of the clients 104-106 or indirectly through the server 100. Although the server 100 can be an individual server, the server 100 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 100 can also be protected by a firewall. When the firewall receives a network packet from the network 102, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 100. If both the source and destination are firewalls, the only addresses visible (i.e., unencrypted) on the network are those of the firewall. The addresses of computers on the internal networks, and, hence, the internal network topology, are hidden (virtual private networking).

In one embodiment, the clients 104-106 are wireless devices that communicate with one or more mobile network operator centers. The network operator centers control the mobile network for the clients 104-106. The network operator centers handle switching and call set-up to the clients 104-106. In one embodiment, the centers support the Personal Communication System (PCS). Another embodiment can support the pan-European digital mobile communication system GSM (Global System for Mobile Communications) and DCS1800 (Digital Communication System). The network operator centers access a Wireless Telephony Application (WTA) server. The WTA server provides WAP access to features of the wireless network provider's telecommunications infrastructure.

The server 100 can communicate with a proxy server that connects between the wireless domain and the World Wide Web. The proxy server includes a protocol gateway that translates requests from the WAP protocol stack to the Web protocol stack (HTTP and TCP/IP). The WAP Gateway layers include the WAP datagram protocol (WDP) which is the transport layer that sends and receives messages via any available bearer network, including SMS, USSD, CSD, CDPD, IS-136 packet data, and GPRS. The WAP gateway layers also include Wireless transport layer security (WTLS), an optional security layer, has encryption facilities that provide the secure transport service required by many applications, such as e-commerce; WAP transaction protocol (WTP) layer that provides transaction support, adding reliability to the datagram service provided by WDP; and the WAP session protocol (WSP) layer that provides a lightweight session layer to allow efficient exchange of data between applications.

The server 100 contains various software applications to efficiently convert, facilitate, communicate and distribute 3D files. In addition, the server 100 maintains a registration database of subscriber and recipient information. The server 100 also provides file management, 3D file format conversion, and email distribution operations, among others. Particularly, the file format conversion allows 3D files transmitted from one 3D vendor to be played. The server 100 also stores applets that can be downloaded to the handheld clients. The applets support customization of client handheld devices 104-106, or can provide value-added features on the client handheld devices 104-106.

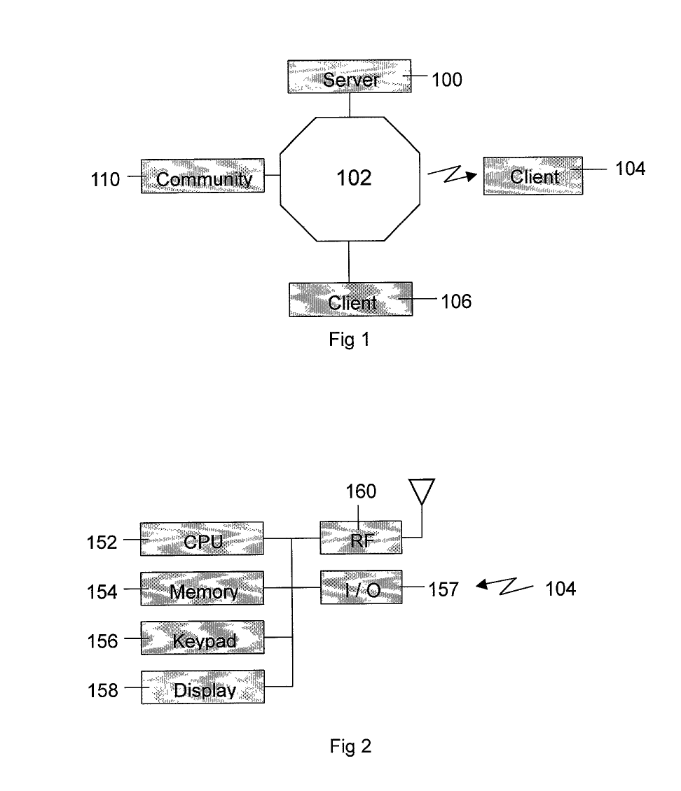

FIG. 2 shows an exemplary handheld device 104. The handheld device 104 has a processor 152 that is connected to memory 154, a keypad 156, a display 158 and suitable radio-frequency (RF) unit 160 to communicate with a mobile network operator. For example, the handheld device 104 can include a radio transmitter and a radio receiver section coupled to various antennas. In one embodiment, the handheld device 104 supports GSM transmission, for example. The handheld device 104 may be connected to one or more input/output (I/O) ports 157 which allow the CPU 152 to communicate with a host computer for data archival purposes. Each of the I/O ports 157 may be a parallel port, a serial port, a PCMCIA port, or alternatively, a proprietary port to enable the computer system to dock with the host computer. After docking, the I/O ports 157 and software located on the host computer supports the automatic synchronization of data between the computer system and the host computer. During operation, the synchronization software runs in the background mode on the host computer and listens for a synchronization request or command from the data logging computer system of the present invention. Changes made on the data logging computer system and the host computer will be reflected on both systems after synchronization. Preferably, the synchronization software only synchronizes the portions of the files that have been modified to reduce the updating times.

In one embodiment, one client handheld device 104 executes a micro-browser from memory. The micro-browser running on the handheld device can support the Wireless Markup Language (WML). WML implements a card and deck metaphor. It contains constructs allowing the application to specify documents made up of multiple cards. An interaction with the user is described in a set of cards, which can be grouped together into a document (commonly referred to as a deck). Logically, a user navigates through a set of WML cards. The user navigates to a card, reviews its contents, may enter requested information, optionally makes choices, and then moves on to another card. Instructions imbedded within cards may invoke services on origin servers as needed by the particular interaction. Decks are fetched from origin servers as needed. WML decks can be stored in ‘static’ files on an origin server, or they can be dynamically generated by a content generator running on an origin server. Each card, in a deck, contains a specification for a particular user interaction.

According to one embodiment, the handheld device 104 incorporates features and functions found in known personal digital assistant devices, in addition to wireless communications capability. The screen of the handheld device 104 allows the user to annotate by voice or keypad entry information relating to addresses, appointments, and to-do items, for example.

Additionally, the handheld device 104 supports software and applications providing the functionality and interface required for 3D graphics operations on a mobile handheld device. This includes but is not limited to the recording, playback, editing, storage, management and transmission off device of a 3D graphics file from the mobile device to a remote server for file conversion and delivery system. The device 104 also supports the capability of receiving 3D graphics files from other mobile devices or from the computer server.

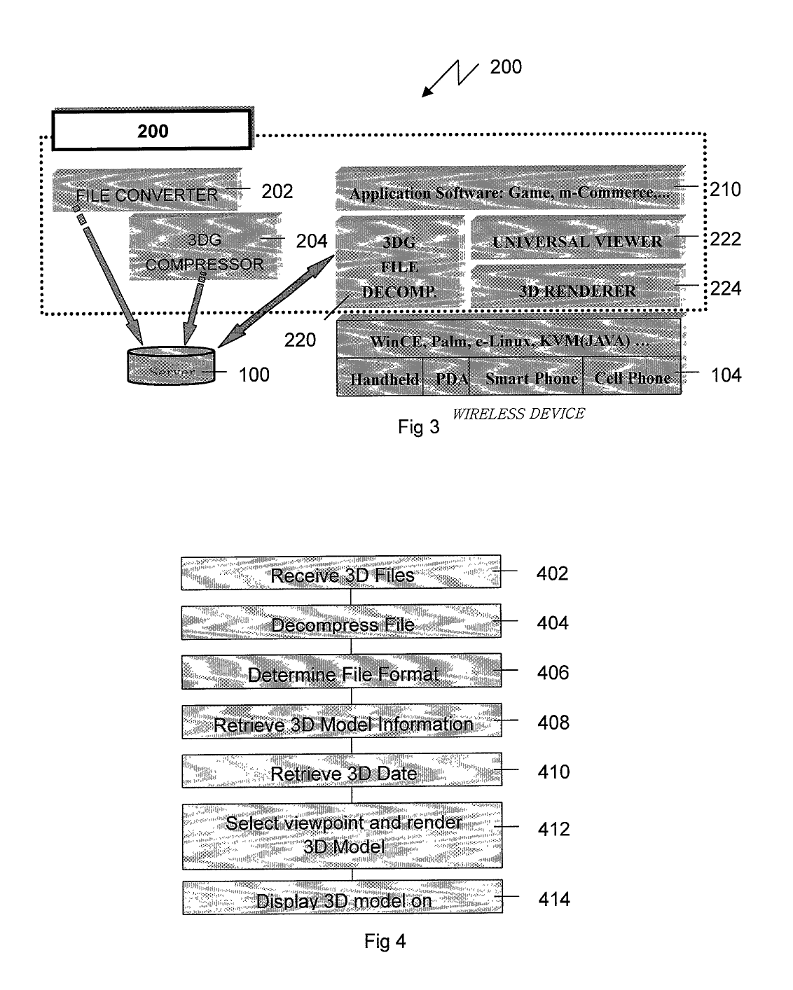

FIG. 3 shows an exemplary architecture 200 for software operating on the server 100. The server 100 supports a file converter 202 and a 3D graphics compression engine 204. The graphics compression engine 204 compresses graphics using a standard such as JPEG, MPEG, or a proprietary protocol. The file converter 202 converts file between a plurality of formats, including formats from Superscape, Cult3D, Viewpoint, and other vendors. These various file formats are translated to one ‘universal’ file format. The translation can be done either on the server 100, the handheld device 104, or other external computers before the file is loaded on to the device 104.

The server 100 stores application software 210 that can be downloaded to the handheld devices. The application software 210 can include handheld game applications or mobile electronic commerce applications, among others. In addition to application software 210, the server stores a 3D graphics file decompression engine 220, a universal viewer 222, and a 3D renderer 224 that can be downloaded to the handheld device. The 3D graphics file decompression engine 220 decompresses graphics files that have been compressed by the 3D graphics compression engine 204 on the server 100. The universal viewer 222 allows the handheld device 104 to view a variety of 3D files, and the 3D renderer 224 allows the handheld device 104 to render 3D graphics on the handheld device's screen.

In one implementation, the viewer 222 understands different types of file formats and displays each file format using its unique file structure. One way is a ‘brute force’ approach where the universal viewer 222 will have separate routines or modules for each of the file format. In this case, the viewer is basically a ‘collection’ of many different viewers, except for the fact that it shares the common graphics renderer 224 (which is still a good code size saving).

In another embodiment, common modules are used to decode multiple formats. This embodiment takes advantages of the fact that even though all proprietary files have different formats, they often have similar structures. For example, a typical graphics file would have any combination of the following four components: polygon structure information, texture information, lighting information, and animation instructions. For each of the components, different file formats would have different sub-structures. In a grossly simplified example, one file may have polygon structure information read 2 bytes at a time, and another would have it read 4 bytes at a time. The universal viewer's polygon structure decoding module would know how many bytes to be read for each of the file formats it supports, and would read them correctly—using one common program, with a unique ‘switch’ value that corresponds to each of the file formats.

FIG. 4 shows an exemplary flowchart 400 for receiving and displaying 3D models on the handheld device 104. First, the handheld computer 104 receives a 3D file over a landline or a wireless communication medium (step 402). The file is decompressed (step 404) and the file format is ascertained (step 406). Based on the format, 3D model information is retrieved (step 408) along with 3D data (step 410). A viewpoint is selected, and the 3D data is processed by a 3D renderer 224 (step 412). The output of the 3D renderer 224 is displayed for the user to view on the universal viewer 222 (step 414).

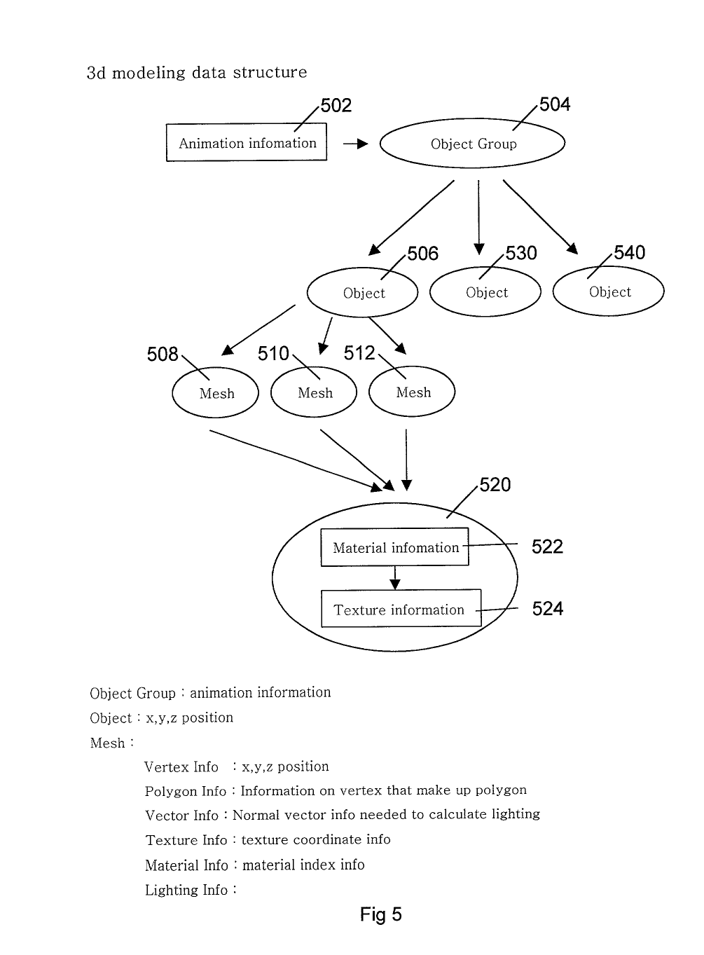

FIG. 5 shows an exemplary 3D model data structure to be rendered on the handheld device by the process of FIG. 4. An animation file 502 provides information on an object group 504. The object group 504 includes a plurality of objects 506, 530 and 540. Each object 506, 530 and 540 includes mesh information, which is detailed next.

Turning now to exemplary object 506, the object 506 includes one or more meshes 508, 510 and 512. The meshes 508-512 provide 3D information 520 that includes material information 522 and texture information 524. The 3D information 520 includes vertex position (x, y, z), polygon information on polygons making up the vertex, lighting information, normal vector information to calculate lighting, texture coordinate information, and material index information. Based on the information, the object can be translated, rotated, and scaled. Further, a camera viewpoint can be translated based on user request.

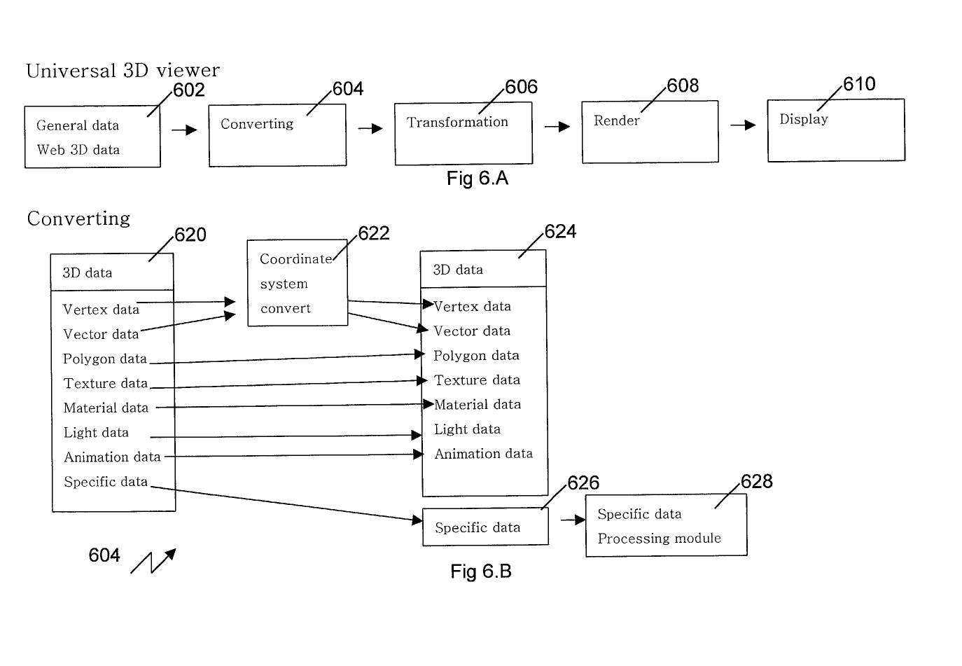

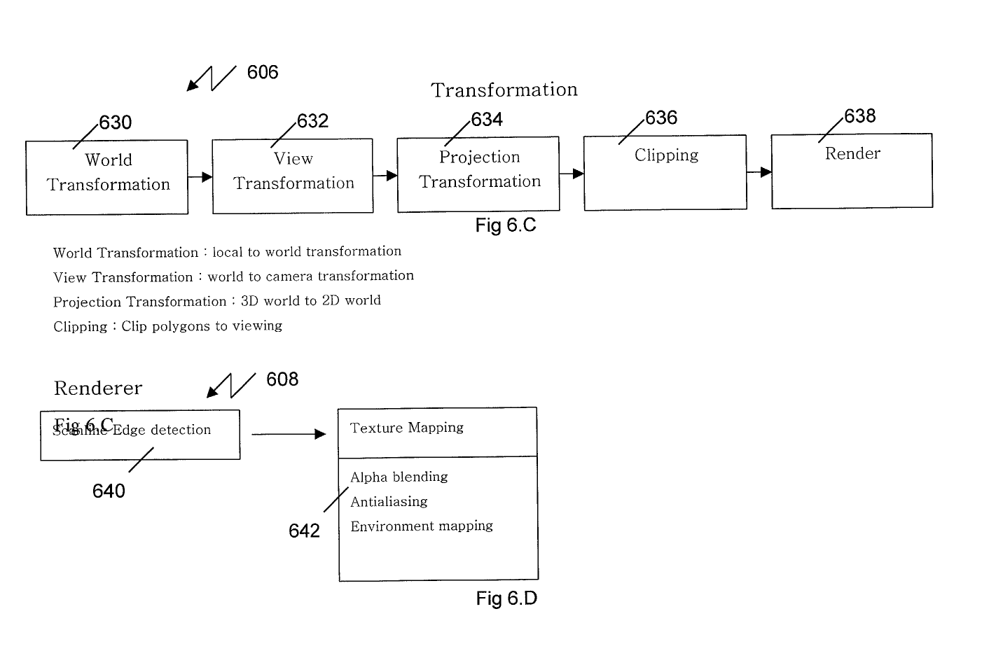

FIGS. 6A-D show block diagrams of a system for visualizing 3D models on the handheld device. Turning now to FIG. 6A, 3D graphics data are received (step 602). The graphics data can be Web 3D data or can be generated by a local desktop computer. The 3D graphics data can be generated by various sources and stored in various file formats. The 3D graphics data are converted into a universal format (step 604). The converted data are then transformed based on camera position, lighting and user modifications (step 606). The data are then rendered (step 608) and displayed for viewing (step 610).

FIG. 6B shows more detail the converting step 604. In this process, 3D data that may be stored in one of many different file formats are analyzed. First, a coordinated system conversion is performed on the vertex data and vector data (step 622). In step 622, the coordinate system conversion is required because the vertex data and vector data in each of the plurality of formats are different from each other so the system makes them uniform and suitable for use on a specific software viewer.

Next, the vertex and vector data are stored in a universal format file. The polygon data, texture data, material data, light data and animation data are copied from the original 3D data into the universal format file as 3D data (step 624). Further, specific data for each of the different file formats are stored separately (step 626) and are processed by specific data processing module (step 628).

Turning now to FIG. 6C, the transformation step 606 is detailed. First, a world transformation operation translates the local coordinate information to the real world or viewing world coordinate (step 630). Next, a world to camera transformation is performed as a view transformation based on the viewing angle (step 632). At this point, the 3D object resides in 3D space that needs to be translated once again to the 2D display of the handheld device (step 634). Clipping operations are performed in step 636 to hide portions of the object that are not going to be shown in the visualization on the handheld device. Finally, the objects are rendered by a renderer (step 638).

FIG. 6D shows in more detail the operation of the renderer. The renderer detects the edges or the boundaries of a polygon or an object to be drawn and draws those boundaries and fill that in so that it becomes an object viewed on the handheld device's screen. The renderer first performs a scanline edge detection (step 640) and then performs texture mapping on the object that has just been created in step 640 (step 642). The texture mapping includes alpha blending, anti-aliasing, and environment mapping.

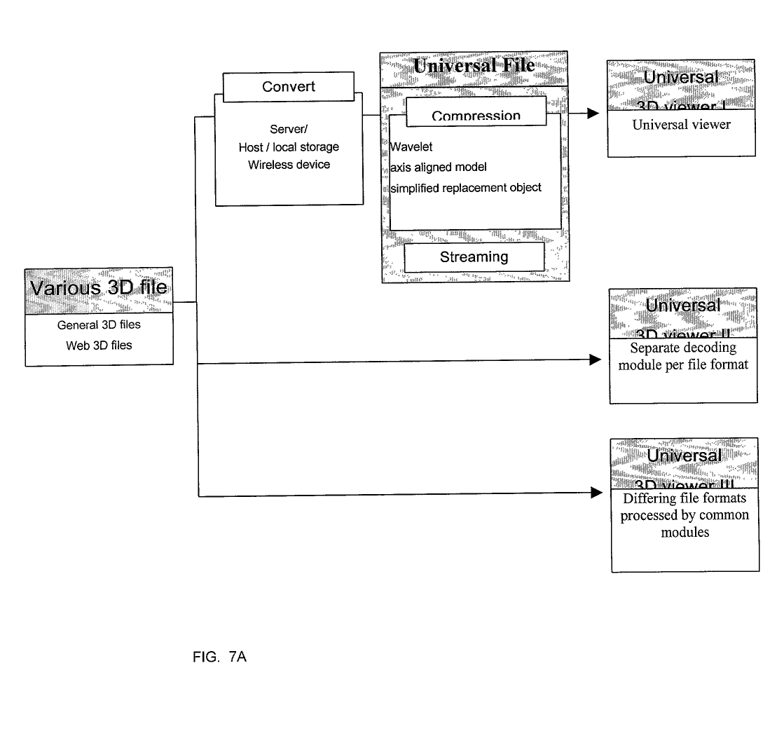

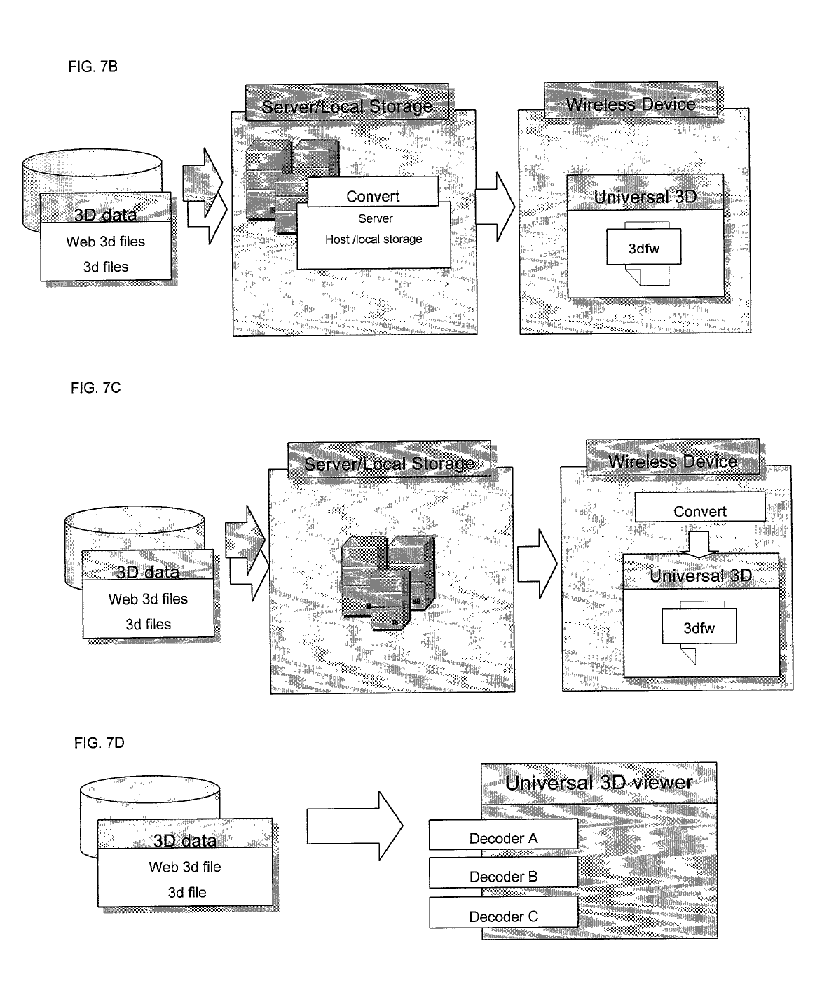

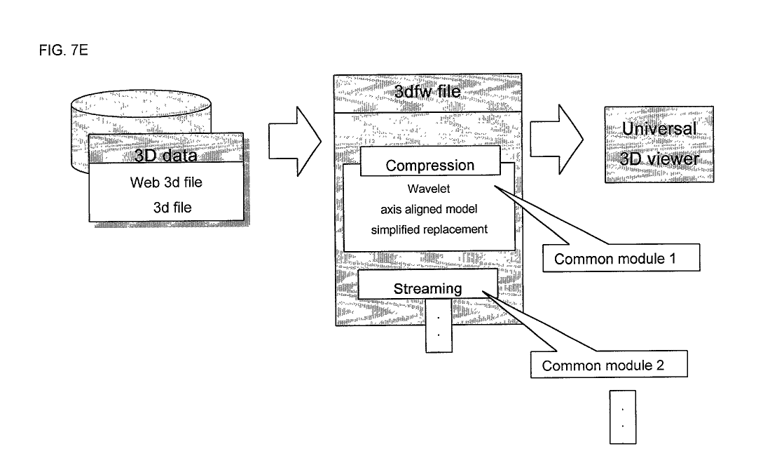

FIG. 7A shows an embodiment for processing 3D graphics files on the handheld device 104, while FIGS. 7B-7E shows various embodiments of a graphics viewer that supports multiple file formats. In FIG. 7A, the graphics file can go directly to the universal viewers for viewing, or can go through intermediate conversion into a universal file format. The system of FIG. 7A allows the user to have only one viewer installed on his/her handheld device and view graphics files with different formats.

The universal viewer may employ one or more of the following exemplary methods. As shown in the embodiment of FIG. 7B, one way is to translate various file formats to one ‘universal’ file format before sending the file to the wireless device to display it. The conversion will be done on a server or other external computing devices before the file is loaded on to the device. As shown in FIG. 7C, a second way is to have different types of 3D files sent to the wireless device, and have the software in the device translate the differing file formats to one type of file format before displaying it on the device. FIG. 7D shows a third way, which is to have a viewer that is really a collection of different types of viewers where each of them recognize one of the many 3D file formats to be recognized. Even though this approach is a collection of different viewers, it is still beneficial because of the fact that it shares a common graphics renderer (which is still a good code size saving). As shown in FIG. 7E, the fourth way is to have a viewer built with common modules that decode multiple formats. This method takes advantages of the fact that even though all proprietary files have different formats, they often have similar structures. For example, a typical graphics file would have any combination of the following four components: polygon structure information, texture information, lighting information, and animation instructions. For each of the components, different file formats would have different sub-structures. In a grossly simplified example, one file may have polygon structure information read 2 bytes at a time, and another would have it read 4 bytes at a time. The universal viewer's polygon structure decoding module would know how many bytes to be read for each of the file formats it supports, and would read them correctly—using one common program, with a unique ‘switch’ value that corresponds to each of the file formats.

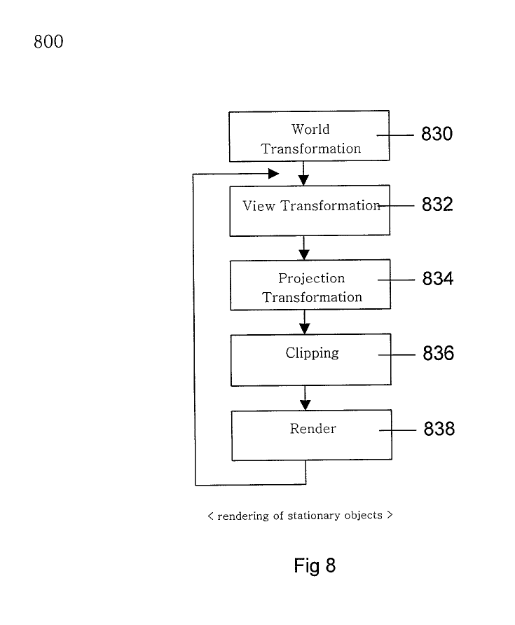

FIG. 8 shows a flowchart of a process 800 to accelerate rendering of 3D objects on the handheld device. The process 800 differs from the process of FIG. 6C in that the world transformation step is performed once for non-moving objects such as buildings. Thus, in FIG. 8, after performing the world transformation operation that translates the local coordinate information to the real word or viewing word coordinate (step 830), a world to camera transformation is performed as a view transformation based on the viewing angle (step 832). At this point, the 3D object resides in 3D space that needs to be translated once again to the 2D display of the handheld device (step 834). Clipping operations are performed in step 836 to hide portions of the object that are not going to be shown in the visualization on the handheld device. The objects are rendered by a renderer (step 838), and the process of FIG. 8 loops back to step 832 rather than looping back to step 830 as in FIG. 6C.

Additionally, to save processing time, the system of FIG. 8 also performs frame skipping where, for even frames, only even lines are drawn. Similarly, for odd frames, only odd lines are drawn. This is equivalent to a software controlled video interlacing.

The system of FIG. 8 also minimizes computation by performing resolution skipping operations on objects. This is done by combining two or more polygons into one to reduce the overall number of polygons that need to be drawn for a particular object. The net effect of this operation results in a more “jagged” object. However, on a small screen, the difference is not noticeable while minimizing computations.

Yet another operation to reduce computation involves approximating an object as a sphere for purposes of lighting transformation such as Gouraud shading transformation. Conventionally, vertex normals are computed for each polygon by averaging the surface normals of all polygons that have the vertex in common. A dot product calculation is performed to compute the light intensity incident on each vertex and then the actual shading is done by interpolation. However, such approach is computation and data storage intensive. The process of FIG. 8 approximates an object as a sphere. By approximating the sphere, the shading can be approximated where each value of the shade can be represented as one or two bytes. Hence, the number of data storage required is reduced. Further, the shading calculation is performed using a table look-up. Thus, floating point calculations are minimized.

In another aspect, the system of FIG. 8 minimizes calculations by skipping the anti-aliasing operations on moving objects and only perform anti-aliasing operations on stationary objects. Due to the small screen size, the anti-aliasing benefits are still achieved using this approach while computations associated with anti-aliasing operations are minimized.

Although the present system has been described as being WAP enabled the system is protocol-independent and is also independent of transmission technology such as Global Packet Radio Services (GPRS), Digital Advanced Mobile Phone System (DAMPS), Integrated Digital Enhanced Networks (iDEN) Enhanced Data Rates for Global Evolution (EDGE), and Third Generation (3G) or Universal Mobile Telecommunication System (UTMS) can be used. Also, the system and method described herein is independent of mobile web-enabling protocols.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A 3D graphics system, comprising:
a server to receive a 3D file, the 3D file conforming to one or more formats; and
a handheld device adapted to communicate with the server the 3D file, the handheld device capable of visualizing the 3D file.

2. The system of claim 1, wherein the server performs file conversion and file compression.

3. The system of claim 1, wherein code is stored on the server and downloaded to the handheld device as needed.

4. The system of claim 1, wherein the 3D rendering code is embedded in the handheld device.

5. The system of claim 1, wherein the handheld device handles recording, playback, editing, storage, conversion, management and transmission of a 3D graphics file from the handheld device to the server.

6. The system of claim 1, wherein the handheld device is a cellular phone, personal digital assistant, smart phone, or a resource-constrained mobile computer.

7. The system of claim 1, wherein the server is connected to the Internet.

8. A mobile 3D visualization system, comprising:
a handheld device adapted to receive graphics files from a plurality of sources conforming to a plurality of file formats; and
a server coupled to the handheld device, the server distributing the 3D graphics file to the device.

9. The system of claim 8, wherein the server performs 3D file conversion and file compression.

10. The system of claim 8, wherein the server contains code for the handheld device to convert, decompress, view, interact with, control and render 3D files.

11. The system of claim 10, wherein the code is downloaded to the handheld device as needed.

12. The system of claim 8, wherein the handheld device further comprises embedded code to perform conversion, decompression, viewing, interacting, controlling, and rendering of graphics files.

13. Software for a 3D graphics mobile device to visualize a 3D graphics file stored in one or more 3D file formats, comprising:
code to converting the file into a universal format;
code to decompress the file; and
code to render the file into a 3D image.

14. The software of claim 13, wherein the render code avoids the rendering of small details not observable on a mobile device screen to accelerate displaying the 3D image on the mobile device.

15. The software of claim 13, further comprising code to perform resolution skipping operations on objects.

16. The software of claim 13, further comprising code to approximating an object as a sphere for purposes of lighting transformation.

17. The software of claim 13, further comprising code to perform anti-aliasing operations only on stationary objects.

18. The software of claim 13, further comprising code to perform frame skipping where, for even frames, only even lines are drawn and, for odd frames, only odd lines are drawn.

19. The software of claim 13, further comprising code to perform world transformation operation only once for non-moving objects 20. The software of claim 13, wherein an input file format is converted into the universal file.
